(19) United States
(12) Patent Application Publication
(10) Pub. No.: US 2008/0113136 A1
(43) Pub. Date: May 15, 2008

(54) Gas bag finished with a flame retardant

(75) Inventor: Monica Schatzmuller-Baragas, Partenstein (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/985,003

(22) Filed: Nov. 13, 2007

(30) Foreign Application Priority Data
Nov. 13, 2006 (DE) 20 2006 017 287.4

(51) Int. Cl. B60R 21/16

(52) U.S. Cl. 428/36.1

(57) ABSTRACT

A gas bag for a vehicle occupant restraint system comprises at least one wall part made of a fabric that is finished with a flame retardant, wherein the flame retardant contains an intumescent material.

The present invention relates to a gas bag for a vehicle occupant restraint system, including at least one wall part made of a fabric that is finished with a flame retardant.

### BACKGROUND OF THE INVENTION

Gas bags or airbags for vehicle occupant restraint systems usually consist of silicone-coated or uncoated polyamide or polyester fabrics. The fabrics are required to allow a specific adjustment of the permeability to air and, in addition, must be heat-resistant. Furthermore, in the interest of requiring as little space as possible for accommodating the gas bag in the vehicle, the fabrics are to exhibit good foldability and a mass that is as low as possible.

It has already been proposed to provide the inside of the gas bags with heat-absorbing means such as for example a film coating or other sacrificial materials. These sacrificial materials are fused or disintegrated by the hot gases flowing into the gas bag and are intended to protect the actual gas bag wall against damage in this way. As an alternative, high-temperature resistant fiber materials having higher melting points as compared to the usual nylon fabrics are intended to be used. The use of sacrificial materials, however, results in a greater layer thickness and also a greater mass of the gas bag fabric. The use of special high-temperature resistant plastics is not justifiable economically.

EP 0 536 723 B1 discloses a gas bag that is formed of a fabric coated with silicone rubber. Generally known flame retardants may be incorporated into the silicone rubber in order to eliminate the need for a further flame retardant coating of the gas bag.

US 2003/0082972 A1 discloses heat-resistant, flame-retardant fabrics which include a substrate that has been treated with a combination of a flame-retardant agent and an intumescent material. The intumescent material consists of a catalyst releasing phosphoric acid, a source of carbon, a resinous material and an expanding agent. The fabrics having a finish of this type are used, inter alia, in vehicle components such as, e.g., in vehicle seats and vehicle doors.

EP 1 253 236 A1 describes a sheet-like fire-resisting material and the use thereof for fire protection of tunnel tubes. The fire-retardant sheet material consists of a textile sheet structure having a coating containing expanded graphite. The textile sheet material can be coated on one or both sides with the coating containing expanded graphite.

Therefore, a need continues to exist for gas bags which can be manufactured at low cost and which exhibit good heat resistance.

### SUMMARY OF THE INVENTION

The invention provides a gas bag for a vehicle occupant restraint system, including at least one wall part made of a fabric that is finished with a flame retardant, wherein the flame retardant contains an intumescent material. Intumescent materials offer the advantage that they expand to several hundred times their original volume under the influence of heat, e.g. by intumescence, swelling or foaming, as a result of which a poorly heat-conducting layer is formed which protects the underlying gas bag fabric. Compared with conventional flame retardants, the use of intumescent materials can thus result in a reduction in the amount of flame retardant, without a deterioration in the heat resistance occurring.

The intumescent material is preferably selected from a group consisting of expanded graphite and a composition which comprises a carbon source, an expanding agent and a catalyst. Preferably, the intumescent material is expanded graphite.

Graphite in which atoms or small molecules are included (intercalated) between the carbon layers of the layer lattice structure of graphite is referred to as expanded graphite. The intercalated molecules are usually aromatic compounds or sulfur or nitrogen compounds which are released upon exposure to heat and thereby drive the carbon layers apart in a concertina fashion.

Also, many different intumescent materials are known which comprise a carbon source, an expanding agent and a catalyst. The carbon source may, for example, consist of carbohydrates, proteins or multifunctional alcohols such as starch, casein or pentaerythritol. Examples of suitable catalysts include inorganic acids such as boric acid, phosphoric acid or sulfuric acid, but may also be compounds which form an inorganic acid upon decomposition. Examples thereof are monoammonium or diammonium phosphates, melamine and urea. The expanding agent of the intumescent materials consists of compounds which, when exposed to heat, release a gas such as ammonia or carbon dioxide. One example thereof is melamine, which in this case is the catalyst at the same time.

In a first embodiment according to the invention, the fabric consists of fibers and the intumescent material is incorporated in the fibers. As a result, a coating of the fabric may be dispensed with. At the same time, the good heat resistance of the fabric is also maintained.

In a second embodiment according to the invention, the fabric consists of fibers and the fibers are coated with the intumescent material. This has the advantage that the intumescent material can be applied onto the fibers as early as during the production of the fibers, as a result of which fewer process steps are necessary in producing the gas bag according to the invention.

In a third embodiment according to the invention, the intumescent material is contained in a coating which is applied on a surface of the fabric. The heat resistance of the fabric may be further improved thereby.

The gas bag that can be obtained in accordance with the above embodiments includes an inside to receive a gas volume, the surface of the fabric treated with the intumescent material directly adjoining the gas volume in the inflated condition of the gas bag. In the inflated condition, i.e. with the gas generator activated, the gas bag fabric is in this way protected in an optimum manner from the hot gas generated by the gas generator.

The coating according to the third embodiment is preferably based on silicone. The fabric according to the first and second embodiments described above, in which the intumescent material is incorporated in the fibers of the fabric or the fibers of the fabric are coated with the intumescent material, respectively, may be additionally finished with a silicone-based coating. Thereby, the heat resistance of the fabric may be further improved.

The finishing of the fabric or of the fibers with the intumescent material may typically be effected by spread-coating, knife-coating or any other desired method, which depends on the viscosity of the intumescent material, among other factors.

Compared with the conventional uncoated fabrics, the fabrics finished with the intumescent material exhibit an increased heat resistance and, compared with the fabrics finished with conventional flame retardants, they exhibit an at least equally good, if not even better heat resistance. Owing to the low layer thicknesses of the coating, a folding of the gas bag is ensured without problems. The buckling strength of the folded gas bag in the gas bag module is also sufficient over a period of time corresponding to the life of the vehicle.

### BRIEF DESCRIPTION OF THE DRAWINGS

Further advantages of the invention will become apparent from the following description of an embodiment and from the drawing, to which reference is made and in which:

FIG. 1 shows a diagrammatic perspective view of a gas bag according to one embodiment of the invention, in the inflated condition.

### DETAILED DESCRIPTION OF PREFERRED EMBODIMENT(S)

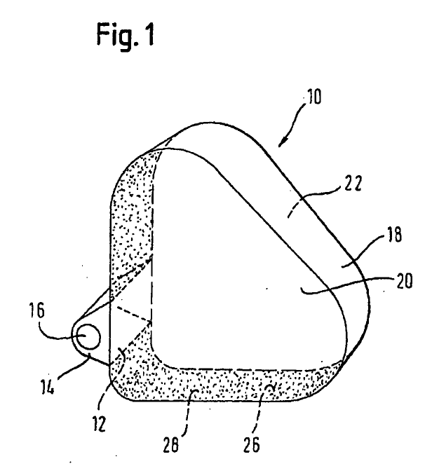

The gas bag 10, shown in FIG. 1 in the inflated condition, of a vehicle occupant restraint system is connected by its orifice 12 to the housing 14 of a gas generator 16. The gas bag 10 shown here consists of a middle wall part 18 and two lateral wall parts 20, 22, which are each constituted by a fabric. Other cuts may be used as well.

The wall parts 18, 20, 22 each have two opposite surfaces, one on the outside of the gas bag and one on the inside of the gas bag, which faces the gas volume flowing out from the gas generator 16 and into the gas bag 10. For a simplified representation, only the surface 26 of the wall part 18 facing the inflowing gas volume is shown in FIG. 1. In the embodiment shown here, the surface 26 on the inside of the gas bag is finished with a coating 28 to increase the heat resistance. The coating 28 is preferably a silicone rubber which contains the intumescent material in a proportion of approximately 10 percent by weight. The intumescent material consists of expanded graphite or a composition which comprises a carbon source, an expanding agent and a catalyst. Expanded graphite is particularly preferred.

The surfaces of the lateral wall parts 20, 22 facing the inside of the gas bag may likewise be finished with the intumescent material. It is also possible to finish only those regions of the wall parts 18, 20, 22 with the intumescent material which are especially heavily exposed to the hot gases flowing out from the gas generator 16. Generally, these are the regions of the gas bag fabric adjacent to the orifice 12 and the regions of the wall parts opposite the orifice 12 in the direction of flow of the hot gases.

Upon activation of the gas generator 16, a propellant charge (not shown) in the gas generator is burnt and produces a hot gas which flows through the orifice 12 into the gas bag 10 to inflate the latter. The hot gas strikes onto the coating 28 of the wall part 18 which contains the intumescent material. Under the influence of heat, the intumescent material is expanded to several hundred times its original volume and forms a poorly heat-conducting layer which protects the underlying gas bag fabric against damage by the hot gas.

The resistance to hot gases exhibited by the gas bag according to the invention is at least just as good as, if not even better than, that of a gas bag finished with a conventional flame retardant. Because of the low coating thickness, the increase in the mass of the gas bag fabric is however only insignificant. As a result, the essential advantages of uncoated gas bags, in particular the lower space requirement in the folded condition, are maintained. The buckling strength of the gas bags formed of the fabric parts finished with the intumescent material is sufficient over a period of time corresponding to the life of the vehicle.

1. A gas bag for a vehicle occupant restraint system,
comprising at least one wall part made of a fabric that is finished with a flame retardant,
wherein the flame retardant contains an intumescent material.

2. The gas bag according to claim 1, wherein the intumescent material is selected from the group consisting of expanded graphite and a composition which comprises a carbon source, an expanding agent and a catalyst.

3. The gas bag according to claim 1, wherein the fabric consists of fibers and the intumescent material is incorporated in the fibers.

4. The gas bag according to claim 1, wherein the fabric consists of fibers and the fibers are coated with the intumescent material.

5. The gas bag according to claim 1, wherein the intumescent material is contained in a coating which is applied on a surface of the fabric.

6. The gas bag according to claim 5, wherein the gas bag has an inside to receive a gas volume, and the surface, treated with the intumescent material, of the fabric directly adjoins the gas volume in the inflated condition of the gas bag.

7. The gas bag according to claim 5, wherein the coating is based on silicone.
